(19) United States
(12) Patent Application Publication
(10) Pub. No.: US 2026/0089501 A1
(43) Pub. Date: Mar. 26, 2026

(54) DISPLAY SYSTEM, DISPLAY DEVICE AND UNLOCKING METHOD THEREOF

(71) Applicant: Optoma Corporation, New Taipei City (TW)

(72) Inventors: Kuo-Ming Wang, New Taipei City (TW); Yu-Cheng Jhuo, New Taipei City (TW)

(73) Assignee: Optoma Corporation, New Taipei City (TW)

(21) Appl. No.: 19/304,608

(22) Filed: Aug. 20, 2025

(30) Foreign Application Priority Data
Sep. 23, 2024 (TW) 113135988

(51) Int. Cl. H04W 12/06; G06F 3/14; H04W 12/63

(52) U.S. Cl. CPC H04W 12/06; G06F 3/14; H04W 12/63

(57) ABSTRACT

A display system, a display device and an unlocking method thereof are disclosed. The display system includes a user terminal device, the display device and a server. The display device obtains location information and a user identification code according to an ultra-wideband signal. The display device determines whether the location information matches a preset condition. The display device sends a verification request signal including the user identification code to the server. The server receives the verification request signal and executes a verification process to verify the user identification code to generate a verification result. The server sends the verification result to the display device. A screen of the display device is unlocked.

### CROSS-REFERENCE TO RELATED APPLICATION

This application claims the priority benefit of Taiwan application serial no. 113135988, filed on Sep. 23, 2024. The entirety of the above-mentioned patent application is hereby incorporated by reference herein and made a part of this specification.

### BACKGROUND

### Technical Field

The disclosure relates to the field of display devices, particularly to an unlocking method of a display device utilizing ultra wideband (UWB) technology, a display system using this method, and a display device.

### Description of Related Art

Interactive flat panel (IFP), as a large-size touch display device, is widely used in educational and commercial fields. However, traditional display devices have the following problems: lack of effective user identification mechanism, allowing anyone to log in and use, making it difficult to distinguish the current user; users need to manually enter account and password to log in, which may cause the leakage of account and password in public places such as classrooms or meeting rooms; and unable to automatically load user's personalized settings for the display device, thereby affecting user experience.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An object of the disclosure is to provide an unlocking method applying ultra wideband (UWB) technology, a display system using this method, and a display device, to solve problems existing in the prior art.

Other objectives, features and advantages of the disclosure will be further understood from the further technological features disclosed by the embodiments of the disclosure wherein there are shown and described preferred embodiments of this disclosure, simply by way of illustration of odes best suited to carry out the disclosure.

To achieve the above one or part or all of the objects or other objects, one embodiment of the disclosure provides an unlocking method, adapted for a display system, the display system comprising a display device, a server and a user terminal device, wherein the display device is communicatively connected to the server, the method comprising: via the user terminal device, continuously transmitting an ultra wideband signal; via the display device, in response to receiving the ultra wideband signal, and obtaining location information of the user terminal device and the display device and a user identification code based on the ultra wideband signal; via the display device, in response to the location information matching a preset condition, sending a verification request signal containing the user identification code to the server; via the server, in response to receiving the verification request signal, performing a verification process on the user identification code and generating a verification result; via the server, transmitting the verification result to the display device, wherein the verification result is configured to indicate whether the user identification code is correct; and via the display device, in response to receiving the verification result, unlocking a screen of the display device.

In one embodiment of the disclosure, via the display device, in response to the verification result, sending a user data request signal to the server, wherein the verification result represents that the user identification code is correct; via the server, in response to receiving the user data request signal, sending user data corresponding to the user identification code to the display device; via the display device, in response to receiving the user data, and performing a personalized setting according to the user data; and via the display device, after the personalized setting is completed, unlocking the screen of the display device.

In one embodiment of the disclosure, wherein the preset condition comprises: a distance between the user terminal device and the display device is less than 50 centimeters; and the user terminal device is located within a range of 0-180 degrees in front of the display device.

In one embodiment of the disclosure, wherein the location information comprises: a distance between the user terminal device and the display device; and an angle of the user terminal device relative to the display device.

In one embodiment of the disclosure, the method further comprising: via the user terminal device, executing an interactive application; via the interactive application, periodically transmitting the ultra wideband signal containing the user identification code.

In one embodiment of the disclosure, wherein the user data comprises: a user personal data, including a user name and a user photo; third-party account information, configured to access files from a third-party account; and setting parameters of a display device.

In one embodiment of the disclosure, wherein when a plurality of user terminal devices are near the display device and match the preset condition, the method further comprises: via the display device, sorting processing order of a plurality of ultra wideband signals sent by the plurality of user terminal devices, wherein the order is based on a distance condition and an angle condition, the distance condition having higher priority than the angle condition.

In one embodiment of the disclosure, wherein the user terminal device is a smartphone having an ultra-wideband communication unit.

One embodiment of the disclosure provides a display system, comprising: a user terminal device; a display device; and a server. The user terminal device transmits an ultra wideband signal; the display device receives the ultra wideband signal; and the server is communicatively connected to the display device, wherein the display device obtains location information of the user terminal device relative to the display device and a user identification code based on the ultra wideband signal; the display device determines whether the location information matches a preset condition, and sends a verification request signal containing the user identification code to the server; the server receives the verification request signal, performs a verification process on the user identification code to generate a verification result, and transmits the verification result to the display device, wherein the verification result indicates whether the user identification code is correct; and the display device receives the verification result, and unlocks a screen of the display device.

In one embodiment of the disclosure, wherein the display device sends a user data request signal to the server; the server receives the user data request signal, sends user data corresponding to the user identification code to the display device; the display device receives the user data, and performs a personalized setting according to the user data; and the display device is configured to unlock the screen of the display device after the personalized setting is completed.

In one embodiment of the disclosure, wherein the preset condition comprises: a distance between the user terminal device and the display device is less than 50 centimeters; and the user terminal device is located within a range of 0-180 degrees in front of the display device.

In one embodiment of the disclosure, wherein the location information comprises: a distance between the user terminal device and the display device; and an angle of the user terminal device relative to the display device.

In one embodiment of the disclosure, wherein the user terminal device executes an interactive application; the user terminal device is configured to execute the interactive application to periodically transmit the ultra wideband signal containing the user identification code.

In one embodiment of the disclosure, wherein the user data comprises: user personal data, including a user name and a user photo; third-party account information, configured to access files from a third-party account; and setting parameters of a display device.

In one embodiment of the disclosure, wherein when a plurality of user terminal devices are near the display device and match the preset condition: the display device is configured to sort processing order of a plurality of ultra wideband signals sent by the plurality of user terminal devices, wherein the order is based on a distance condition and an angle condition, the distance condition having higher priority than the angle condition.

One embodiment of the disclosure provides a display device, comprising: an ultra-wideband communication unit, a storage device, a processor, and a screen. The ultra-wideband communication unit receives an ultra wideband signal; the storage device stores a preset condition; the processor is electrically coupled to the ultra-wideband communication unit and the storage device, wherein the processor is configured to: obtain location information and a user identification code based on the ultra wideband signal, determine the location information matches the preset condition; a communication unit is electrically coupled to the processor, sends a verification request signal containing the user identification code, and receives a verification result, wherein the verification result indicates whether the user identification code is correct; and a screen is electrically coupled to the processor, unlocks the screen according to the verification result.

In summary, the embodiments of the unlocking method, the display system using this method, and the display device of the disclosure can achieve the following technical effects:

Accurate user identification: Utilizing UWB technology to achieve accurate position sensing and user identification, solving the problem of traditional display devices being unable to distinguish users.

Enhanced security and convenience: Through preset condition judgment and verification process, ensuring that only authorized user terminal devices within a specific range can trigger the automatic unlocking of the display device, avoiding accidental operation and leakage of user's account and password, while improving usage convenience.

Personalized experience: Supporting the display device to automatically load user's setting parameters for the display device, quickly adapting to different users' preferences, providing personalized user experience.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a display system according to an embodiment of the disclosure.

FIG. 2A is a block diagram of a display device according to an embodiment of the disclosure.

FIG. 2B is a block diagram of a user terminal device according to an embodiment of the disclosure.

FIG. 3 is a flowchart of an unlocking method of a display system according to an embodiment of the disclosure.

FIG. 4 is a schematic diagram of location information of a user terminal device matching a preset condition according to an embodiment of the disclosure.

FIG. 5 is a flowchart of an unlocking method of a display device according to an embodiment of the disclosure.

FIG. 6 is a sequence diagram of a display system according to an embodiment of the disclosure.

### DESCRIPTION OF THE EMBODIMENTS

The aforementioned and other technical content, features and effects of the disclosure will be clearly presented in the following detailed description of a preferred embodiment with reference to the accompanying drawings.

n the following embodiments, the directional terms mentioned, such as: up, down, left, right, front or back, etc., are only referenced to the direction of the accompanying drawings. Therefore, the directional terms used are for explanation and not for limiting the disclosure.

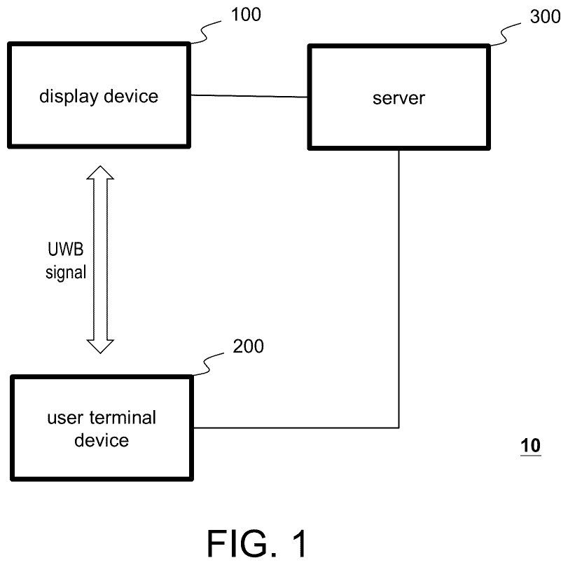

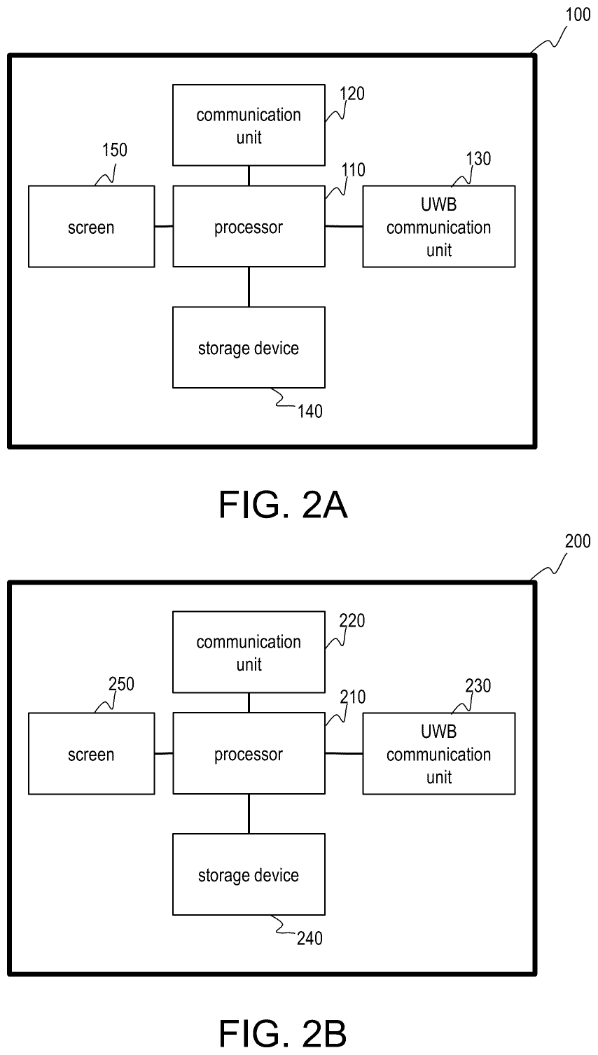

FIG. 1 is a block diagram of a display system according to an embodiment of the disclosure. FIG. 2A is a block diagram of a display device according to an embodiment of the disclosure. FIG. 2B is a block diagram of a user terminal device according to an embodiment of the disclosure.

Referring to FIG. 1, in one embodiment, a display system 10 includes a display device 100, a user terminal device 200, and a server 300. The display device 100, for example, is an Interactive Flat Panel display (abbreviated as IFP display). An interactive flat panel is a device that combines a large-size display and touch technology. The user terminal device 200 can be a smartphone, tablet computer, or other mobile smart device.

Referring to FIG. 2A, the display device 100 includes a processor 110, a communication unit 120, an ultra-wideband (UWB) communication unit 130, a storage device 140, and a screen 150. The processor 110 is electrically coupled to the communication unit 120, the UWB communication unit 130, the storage device 140, and the screen 150, respectively.

The processor 110 is configured to execute at least one program code, interactive application, and preset condition stored in the storage device 140 to implement various functions of the display device 100, including but not limited to receiving and transmitting UWB signals, analyzing location information of the user terminal device 200, verifying user identification code, unlocking the screen, and other operations. The so-called unlocking the screen is defined as allowing a user to make the screen display different images or display a user interface. Via the Internet, the communication unit 120 is configured to establish a communication connection with the server 300, such as sending verification request signals and receiving user data. The UWB communication unit 130 receives UWB signals from the user terminal device 200 and passes the received UWB signals to the processor 110 for signal processing.

A user installs an interactive application on the display device 100. The storage device 140 is configured to store an operating system, at least one program code, at least one application, and various data. The at least one application includes, for example, an interactive application, and various data such as user data, setting parameters of the display device, and temporarily or non-temporarily stored data required for computation. The screen 150 is configured to display various display interfaces and information, and to present user's personalized settings after the display device 100 is unlocked. The processor 110 can execute at least one program code to implement the unlocking method provided by the disclosure.

As shown in FIG. 2B, in one embodiment, the user terminal device 200 includes a processor 210, a communication unit 220, a UWB communication unit 230, a storage device 240, and a screen 250. The user terminal device 200 has a similar hardware architecture to the display device 100, and these components have similar functions to the corresponding components of the display device 100. The processor 210 is electrically coupled to the communication unit 220, the UWB communication unit 230, the storage device 240, and the screen 250, respectively.

The processor 210 of the user terminal device 200 is configured to execute an interactive application stored in the storage device 240, which is configured to initiate the transmission of UWB signals and transmit a user identification code. The UWB communication unit 230 is configured to transmit and receive UWB signals, and the UWB signals contain location information and a user identification code. Via the Internet, the communication unit 220 is configured to establish a communication connection with the server 300.

Referring again to FIG. 1, the server 300 includes a processor, a communication unit, and a storage device. The processor is electrically coupled to the communication unit and the storage device, respectively. The server 300 has a similar hardware architecture to the user terminal device 200, which will not be described again. The storage device of the server 300 is configured to store user identification codes and a verification process.

The processor 110, 210 mentioned above is, for example, a Microprogrammed Control Unit, a Central Processing Unit (CPU), a programmable Microprocessor, an Application Specific Integrated Circuits (ASIC), a Programmable Logic Device (PLD), or an integrated device of the above devices.

The communication unit 120, 220, for example, is a communication chip or communication circuit, which can support at least one or a combination of Global System for Mobile Communication (GSM) system, Wireless Fidelity (WiFi) system, but not limited to these.

The UWB communication unit 130, 230, for example, is a UWB communication chip or UWB communication circuit, used for transmitting and receiving UWB signals.

The storage device 140, 240 is, for example, any type of Hard disk drive (HDD), non-volatile memory storage device (such as SSD or flash memory), Dynamic Random Access Memory (DRAM), Static Random Access Memory (SRAM), etc., or a combination thereof.

The screen 150, 250 is configured to display various information and control interface images. The screen 150, 250, for example, is a touch screen, used to display various information and control interface images. The touch screen is, for example, a liquid crystal panel with a touch device or an LED panel with a touch device, etc. The disclosure does not limit this.

UWB signals include a first signal, a second signal, and a third signal. Referring again to FIG. 1, the UWB communication unit 130 of the display device 100 is configured to receive the first signal and transmit the second signal. The UWB communication unit 230 of the user terminal device 200 is configured to receive the second signal and transmit the first signal and the third signal. The user terminal device 200 and the display device 100 establish a UWB communication connection. The first signal, the second signal, and the third signal belong to UWB signals.

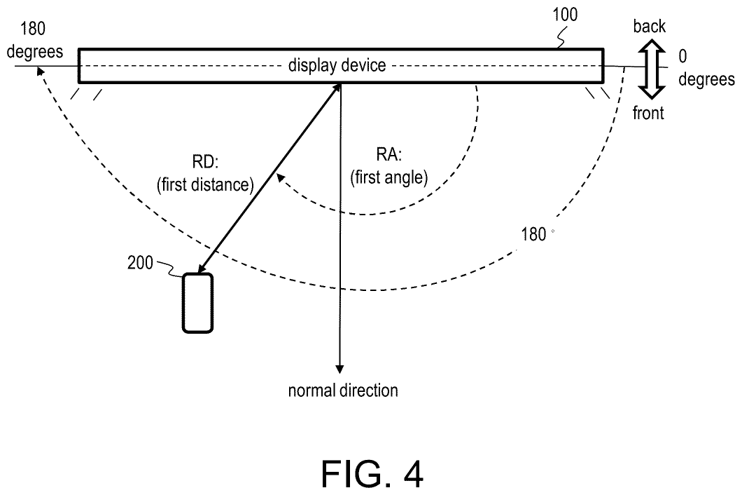

In one embodiment, a user is in a space with physical surroundings, such as a meeting room or classroom, and carries a user terminal device 200 approaching the display device 100. The user terminal device 200 does not need to execute or operate any application on the screen 250 to connect with the display device 100. The user terminal device 200 continuously transmits the first signal. The display device 100 is in standby mode, and the screen 150 of the display device 100 is in a locked state and displays a locked image. The display device 100 continuously receives UWB signals in the surrounding environment. After the display device 100 receives the first signal, it identifies the request information in the first signal, and the display device 100 sends the second signal to the user terminal device 200. The user terminal device 200 establishes a UWB communication connection with the display device 100. The processor 210 of the user terminal device 200, based on the time difference between sending and receiving the first signal and the second signal, executes the Time of Flight (ToF) technology program to obtain the first distance between the user terminal device 200 and the display device 100. In addition, the processor 210 of the user terminal device 200 executes the Angle of Arrival (AOA) technology program to obtain the phase difference between the first signal and the second signal. The processor 210 of the user terminal device 200, based on the time difference and phase difference between the first signal and the second signal, obtains the azimuth angle (also called the first angle) of the user terminal device 200 relative to the display device 100 through triangulation (see FIG. 4). Then, the user terminal device 200 generates location information of the user terminal device 200 and the display device 100, which includes the first distance and the first angle.

Next, the user terminal device 200 further transmits the third signal, which includes the location information and a user identification code, so that the display device 100 can obtain the location information between the user terminal device 200 and the display device 100 and the user identification code.

It should be noted that the disclosure is not limited to calculation by the user terminal device 200 to generate location information between the user terminal device 200 and the display device 100. For example, in one embodiment, a user carries a user terminal device 200 approaching the display device 100. The user terminal device 200 does not need to execute or operate any interactive application on the screen 250 to connect with the display device 100. The user terminal device 200 continuously transmits the first signal. The display device 100 continuously receives UWB signals in the surrounding environment. After the display device 100 receives the first signal, it identifies the request information in the first signal, and the display device 100 sends the second signal to the user terminal device 200. The user terminal device 200 establishes a UWB communication connection with the display device 100. The user terminal device 200 transmits the third signal, which includes a user identification code. The processor 110 of the display device 100, based on the time difference between sending and receiving the second signal and the third signal, executes the Time of Flight (ToF) technology program to obtain the first distance between the user terminal device 200 and the display device 100. In addition, the processor 110 of the display device 100 executes the Angle of Arrival (AOA) technology program to obtain the phase difference between the second signal and the third signal. The processor 110 of the display device 100, based on the time difference and phase difference between the second signal and the third signal, obtains the azimuth angle (first angle) of the user terminal device 200 relative to the display device 100 through triangulation. Then, the processor 110 of the display device 100 generates location information between the user terminal device 200 and the display device 100, which includes the first distance and the first angle. Therefore, the display device 100 obtains the location information between the display device 100 and the user terminal device 200 and the user identification code.

In one embodiment, the display device 100 and the user terminal device 200 establish a UWB communication connection through their respective UWB communication units (130 and 230), achieving precise distance and angle measurements. The processor 110 of the display device 100 is responsible for processing the location information and deciding whether to trigger the unlocking process and establish a communication connection with the server 300 based on the preset condition. Meanwhile, the communication units (120 and 220) ensure secure communication with the server 300 for verifying user identity and transmitting information.

In one embodiment, the user identification code can be a unique character sequence used to define a user. It is worth mentioning that when a user uses the display system 10, the user installs an interactive application on the user terminal device (such as a smartphone) 200. The screen 250 is configured to display the user interface of the interactive application. The user logs in with an account and password on the user interface, enabling the user terminal device to establish a communication connection with the server 300, allowing the user to store user data (such as user personal basic information, name, date of birth, etc.) and setting parameters of the display device (personalized settings). The server 300 generates a user identification code corresponding to the user account and stores it in the storage device of the server 300. The server 300 transmits the user identification code to the user terminal device 200, and the storage device 240 of the user terminal device 200 stores the user identification code.

In addition, the screen 250 is configured to display the user interface of the interactive application, allowing users to make various settings through the displayed user interface of the interactive application, such as enabling or disabling the “unlocking function when near the display device.” If “unlocking function when near the display device” is enabled, the user terminal device 200 does not need to execute or operate the interactive application on the screen 250. When the user terminal device 200 approaches the display device 100 and matches the preset condition, the screen 150 of the display device 100 is unlocked, allowing the user to operate other applications on the screen 150.

In actual use, the UWB communication unit 230 of the user terminal device 200 will transmit a UWB signal (such as the third signal) containing this user identification code. When a user carrying the user terminal device 200 approaches the display device 100, the user terminal device 200 establishes a UWB communication connection with the display device 100, and the UWB communication unit 130 of the display device 100 will receive the user identification code. The display device 100 determines whether the location information matches the preset condition. If the location information matches the preset condition, the display device 100 will send this user identification code to the server 300. The server 300 will execute a verification process to determine whether the user identification code is correct, that is, whether it exists in the storage device of the server 300. In one embodiment, the server 300 can also determine whether the user identification code has permission to use the display device.

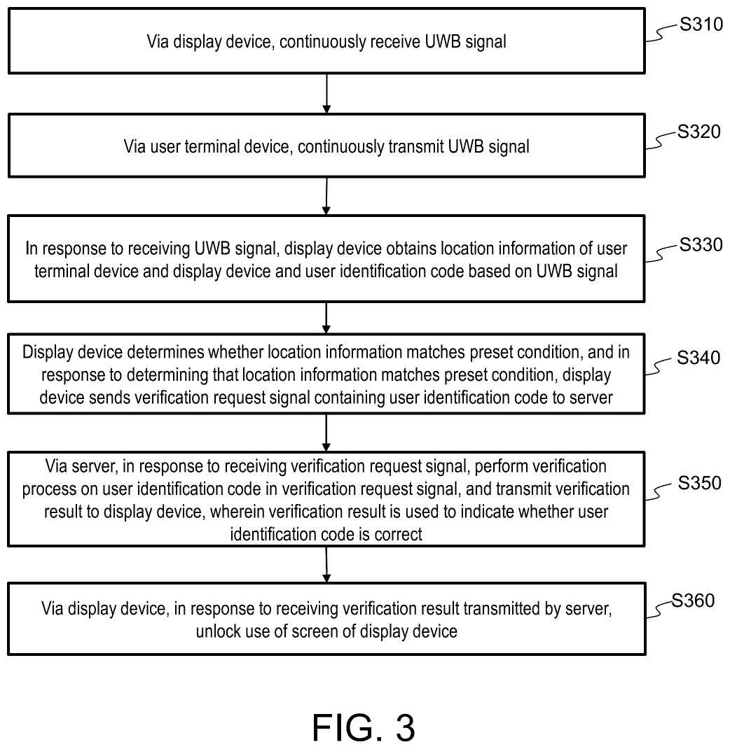

FIG. 3 is a flowchart of an unlocking method of a display system according to an embodiment of the disclosure.

Referring to FIG. 3, in one embodiment, the disclosure provides an unlocking method of a display system including the following steps (S310-S360):

Step S310: Via the display device, continuously receive UWB signals. In this step, the UWB communication unit 130 of the display device 100 is in a continuous receiving state, receiving UWB signals from the surrounding environment at any time.

Step S320: Via the user terminal device, continuously transmit UWB signals. The interactive application installed on the user terminal device 200 (such as a smartphone) will activate the UWB service in the background, periodically transmitting UWB signals. It should be noted that the disclosure does not limit the order of steps S310 and S320. For example, in another embodiment, step S320 can be executed before step S310, or these two steps can be executed simultaneously.

In one embodiment, the user terminal device 200 executes an interactive application. The specific implementation is as follows:

Interactive application installation and setup: The user installs an interactive application on the terminal device 200. The interactive application is stored in the storage device 240 of the user terminal device 200 and executed by the processor 210. The login process of the interactive application can support multiple methods, such as email/password, phone number/verification code, or third-party account (such as Google, Facebook) authorization login. After the user successfully logs in, the interactive application will request a unique user identification code from the server 300. The server 300 generates a user identification code, establishes an association with the user account, and the user identification code is stored in the storage device of the server 300. The server 300 sends the user identification code to the user terminal device 200.

UWB service background execution: The interactive application runs in the background on the user terminal device 200. This background service is the UWB communication unit 230 of the user terminal device 200, periodically transmitting UWB signals. This ensures that even if the interactive application is not running in the foreground, UWB signals can still be continuously transmitted.

Setting options provided: The interactive application provides a user interface through the screen 250 of the user terminal device 200, which includes options allowing users to enable or disable the “unlocking function when near the display device.” This gives users control over the automatic unlocking function of the display device.

Step S330: In response to receiving the UWB signal, the display device 100, based on the UWB signal, obtains location information of the user terminal device 200 and the display device 100 and obtains a user identification code. In one embodiment, the processor 110 of the display device 100 analyzes the received UWB signal to obtain the user identification code and location information including the distance between the user terminal device 200 and the display device 100 in the UWB signal.

Step S340: The display device 100 determines whether the location information matches the preset condition. In response to determining that the location information matches the preset condition, the display device 100 sends a verification request signal containing the user identification code to the server 300. However, the display device 100 determines that the location information does not match the preset condition. In response to determining that the location information does not match the preset condition, the display device 100 will not send a verification request signal containing the user identification code to the server 300. In addition, the screen 150 of the display device 100 continues to display the locked image. That is, the display device 100 maintains the original locked state.

The preset condition mentioned above includes that the distance between the user terminal device 200 and the display device 100 is less than 50 centimeters, and the user terminal device 200 is located within a range of approximately 0-180 degrees in front of the screen 150 of the display device 100. If the location information matches these conditions, the display device 100 sends a verification request signal containing the user identification code to the server 300 through its communication unit 120. If the user terminal device 200 establishes a UWB communication connection with the display device 100, the distance between the user terminal device 200 and the display device 100 is less than 50 centimeters, but the user terminal device 200 is located at an angle exceeding the range of 0-180 degrees in front of the screen 150 of the display device 100, the display device 100 will not send a verification request signal containing the user identification code to the server 300.

FIG. 4 is a schematic diagram of location information of a user terminal device matching a preset condition according to an embodiment of the disclosure.

Referring to FIG. 4, in one embodiment, the unlocking method of the disclosure involves precise judgment of location information and setting of preset conditions. As shown in FIG. 4, the method utilizes ultra wideband (UWB) technology to determine the relative position relationship between the user terminal device 200 and the display device 100.

More specifically, the acquisition of location information includes distance measurement and angle measurement.

Distance measurement: Measurement of the first distance RD as shown in FIG. 4. Through establishing a UWB communication connection between the UWB communication unit 230 of the user terminal device 200 and the UWB communication unit 130 of the display device 100. By utilizing the Time of Flight (ToF) algorithm via the processor 210 of the user terminal device 200, the first distance RD between the user terminal device 200 and the display device 100 is precisely calculated and obtained, providing centimeter-level distance precision. In one embodiment, the processor 110 of the display device 100 utilizes the Time of Flight (ToF) algorithm to precisely calculate and obtain the first distance RD between the user terminal device 200 and the display device 100, providing centimeter-level distance precision.

Angle measurement: Measurement of the first angle RA as shown in FIG. 4. Through establishing a UWB communication connection between the UWB communication unit 230 of the user terminal device 200 and the UWB communication unit 130 of the display device 100. By utilizing the Angle of Arrival (AOA) algorithm via the processor 210 of the user terminal device 200, the first angle RA of the user terminal device 200 relative to the display device 100 is precisely calculated and obtained. The normal direction of the front (the surface displaying images) of the screen 150 of the display device 100 is toward the front of the display device 100, the right side of the front of the screen 150 of the display device 100 is 0 degrees (the right side of the figure), and the left side of the front of the screen 150 is 180 degrees. The first angle RA is the azimuth angle of the user terminal device 200 relative to the display device 100, calculated from the right side of the front of the screen 150 of the display device 100. For example, as shown in FIG. 4, the first angle RA is 120 degrees. In one embodiment, the left side of the front of the screen 150 can be 0 degrees, and the right side of the front of the screen 150 can be 180 degrees.

In one embodiment, the preset condition includes a distance condition and an angle condition, both of which must be satisfied.

Distance condition: In this embodiment, the preset condition requires that the first distance RD between the user terminal device 200 and the display device 100 is less than X centimeters (distance threshold). This distance limitation ensures that the unlocking of the display device 100 is triggered only when the user is indeed close to the display device 100. X is, for example, 50 cm.

Angle condition: As shown in FIG. 4, the preset condition also requires that the user terminal device 200 is located within a range of 0-180 degrees in front of the display device 100. This range is defined by the semicircular area in front of the display device 100 (angle range: 0-180 degrees), ensuring that only user terminal device 200 standing in front of the display device 100 can trigger the unlocking of the display device 100.

For example, when a user carrying the terminal device 200 approaches the display device 100, the UWB communication unit 130 of the display device 100 will receive UWB signals sent by the user terminal device 200. The processor 110 of the display device 100 determines whether the first distance RD is less than 50 centimeters (less than the distance threshold) and determines whether the first angle RA is within the range of 0-180 degrees in front of the screen 150 (less than 180 degrees, the angle threshold).

Only when both of these preset conditions are simultaneously satisfied, the display device 100 will proceed to the next step, which is sending a verification request signal to the server 300. This precise position determination effectively prevents accidental unlocking situations, for example: User A is in Meeting Room No. 1, the display device 100 is in Meeting Room No. 1, User B is in Meeting Room No. 2. When the distance between User B and the display device 100 in Meeting Room No. 1 is less than the distance threshold, User B in Meeting Room No. 2 may stand behind the display device 100 (outside the 180-degree range), thus solving the problem of the display device 100 in Meeting Room No. 1 being unlocked by the user terminal device 200 of User B in Meeting Room No. 2, resulting in User A in Meeting Room No. 1 being unable to use it.

By combining the dual judgment of distance and angle, this method greatly improves the accuracy and security of unlocking, ensuring that only when the user terminal device 200 is in front of the screen of the display device and close to the display device, can it trigger the unlocking of the display device.

Returning to FIG. 3. Step S350: Via the server 300, in response to receiving the verification request signal, performing a verification process on the user identification code in the verification request signal, and generating a verification result. Via the server 300, transmitting the verification result to the display device 100, wherein the verification result is configured to indicate whether the user identification code is correct.

In one embodiment, after the server 300 receives the verification request signal, it determines whether the user identification code exists in its storage device, and determines the permission status of the user identification code. After the verification is completed, the server 300 generates a verification result, and the server 300 returns the verification result to the display device 100. In one embodiment, the server 300 first determines whether the received user identification code exists in the storage device. If it exists, the server checks the status of the user identification code in the verification request signal (whether it is valid, whether the permission has expired, etc.). In addition, the server 300 can query the permission settings associated with the user identification code, for example, determining whether the user has permission to use the display device 100.

In one embodiment, based on the implementation of the above verification process, the server 300 generates a verification result. This verification result may be a simple Boolean value (indicating whether the user identification code is correct or incorrect), or contain more detailed information (such as including the usage period and usage time of the user identification code).

Step S360: Via the display device 100, in response to receiving the verification result (the user identification code is correct) transmitted by the server 300, unlocking the screen 150 of the display device 100. That is, after determining that the user identification code is correct via the verification result, the processor 110 instructs the screen 150 to display images and be operated by the user. The aforementioned images are different from the locked image.

In another embodiment, after determining that the user identification code is correct, before unlocking the screen 150 of the display device 100, the method further includes the following steps:
(1) Via the display device 100, in response to receiving the verification result (the user identification code is correct) transmitted by the server, sending a user data request signal to the server 300. The user data request signal is configured to request the server to provide user data corresponding to the user identification code.
(2) Via the server 300, in response to receiving the user data request signal, sending user data corresponding to the user identification code to the display device 100. The user data may include user personal data (such as name, photo), third-party account information (such as cloud drive account and password) configured to access files from a third-party account (cloud drive account), and setting parameters of the display device (personalized settings, such as desktop background or various settings of the operating environment). The user data is stored in the storage device of the server 300.
(3) Via the display device 100, in response to receiving the user data, storing the user data in the storage device 140, and the processor 110 of the display device 100 performing a personalized setting corresponding to the user data according to the user data.
(4) Via the display device 100, unlocking the screen 150 of the display device 100, the screen 150 can display images or user interfaces with user personalized settings.

These steps ensure that after unlocking the display device 100, the user can immediately see a personalized working environment, greatly enhancing the user's experience and work efficiency. At the same time, this method also protects the security of user data, because user data is only transmitted from the server 300 to the display device 100 after the user identity verification is successful.

In one embodiment, personalized setting refers to adjusting various settings and functions of the display device 100 according to user preferences and needs. This information of adjustments and settings can form user data. The user data includes: user personal data, including user name and user photo; interactive system setting templates, for setting the working environment of the display device; third-party account information, for accessing files from third-party accounts; and settings of the display device, including personalized settings of the operating system of the display device. Personalized settings are designed to provide a tailored user experience for each user, improve work efficiency, and enhance user satisfaction. Through personalized settings, the display device 100 can provide a dedicated working environment for each user. This not only greatly improves the user's work efficiency but also enhances the flexibility and adaptability of the display system. No matter which display device the user logs in to, they can quickly enter their familiar working state.

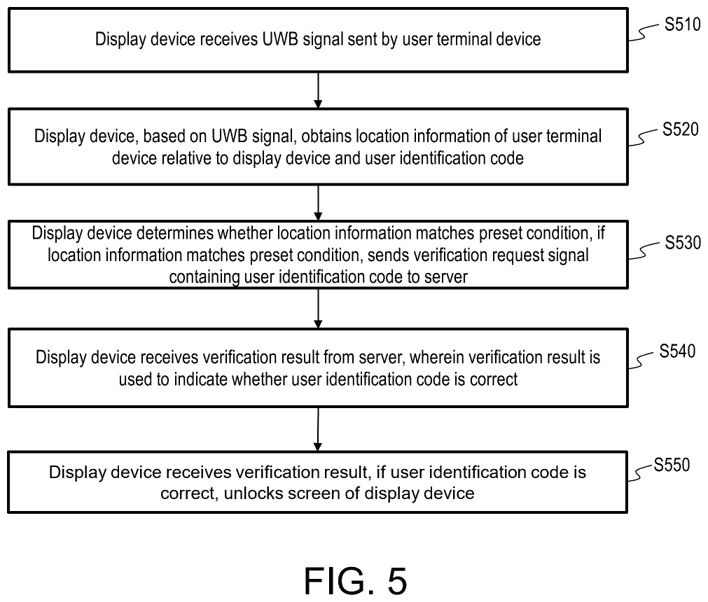

FIG. 5 is a flowchart of an unlocking method of a display device according to an embodiment of the disclosure.

Referring to FIG. 5, in one embodiment, the disclosure provides an unlocking method applicable to the display device 100. The method includes the following steps:

Step S510: The display device 100 receives a UWB signal sent by the user terminal device 200. The UWB communication unit 130 of the display device 100 continuously receives UWB signals in the surrounding environment. When a user carrying the terminal device 200 approaches the display device 100, the UWB communication unit 130 will receive UWB signals emitted by the user terminal device 200.

Step S520: The display device 100, based on the UWB signal, obtains location information of the user terminal device 200 relative to the display device 100 and a user identification code.

Step S530: The display device 100 determines whether the location information matches a preset condition. If the location information matches the preset condition, the display device 100 sends a verification request signal containing the user identification code to the server 300. Further explanation, when the display device 100 determines that the location information matches the preset condition, the communication unit 120 of the display device 100 sends a verification request signal containing the user identification code to the server 300.

Step S540: The display device 100 receives a verification result from the server 300, wherein the verification result is configured to indicate whether the user identification code is correct. After receiving the verification request signal containing the user identification code, the server 300 performs a verification process to determine whether the user identification code exists in the storage device of the server 300, and whether it has permission to use the display device 100.

Step S550: The display device 100 receives the verification result. If the user identification code is correct, it unlocks the screen 150 of the display device 100.

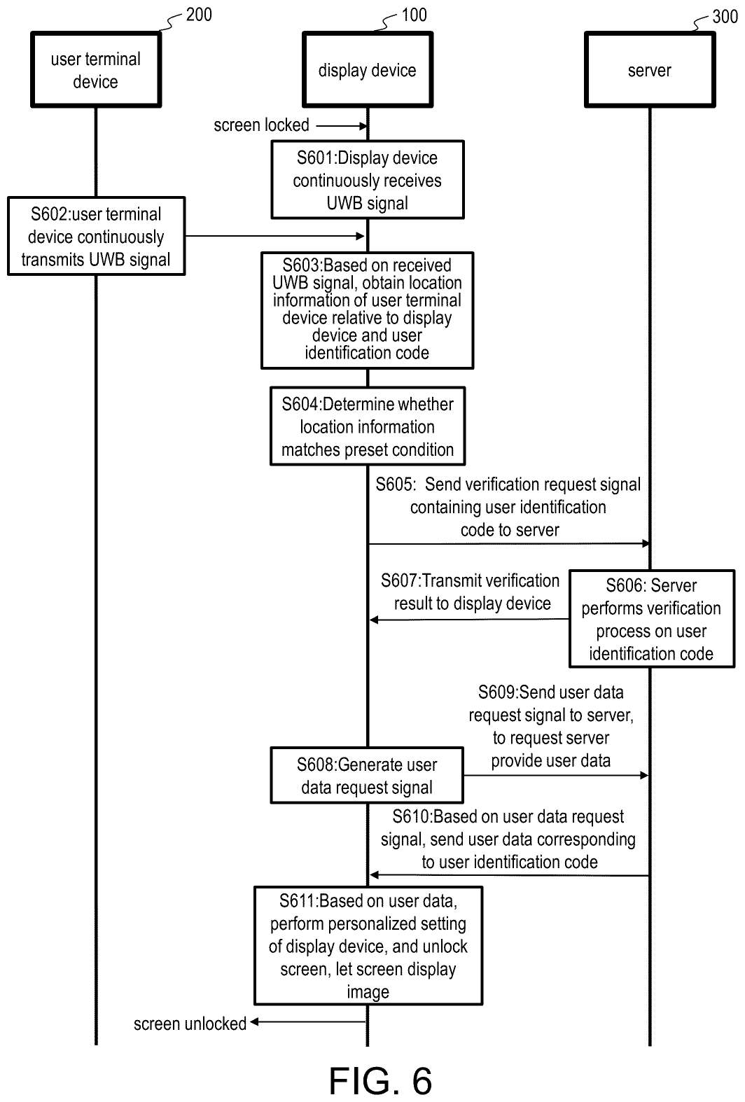

FIG. 6 is a sequence diagram of a display system according to an embodiment of the disclosure.

Referring to FIG. 6, in one embodiment, the disclosure provides a display system and its operating method. The system 10 includes a user terminal device 200, a display device 100, and a server 300. The operation process of the display system 10 is as follows:

Initial state: The display device 100 is in standby mode. The screen 150 of the display device 100 is in a locked state and displays a locked image.

UWB signal transmission (steps S601, S602): The display device 100 continuously receives UWB signals (S601). The user terminal device 200 continuously transmits UWB signals (S602).

Location information analysis (steps S603, S604): The user terminal device 200 establishes a UWB communication connection with the display device 100. The display device 100, based on the received UWB signals, obtains location information of the user terminal device 200 relative to the display device 100 and a user identification code (S603). The display device 100 determines whether the location information (including distance information and angle information) matches the preset condition (S604). The preset condition may include a distance threshold and an angle range.

Verification (steps S605, S606, S607): If the location information matches the preset condition, the display device 100 sends a verification request signal containing the user identification code to the server 300 (S605). If the location information does not match the preset condition, the display device 100 will not send a verification request signal containing the user identification code to the server 300. In addition, the screen 150 of the display device 100 continues to display the locked image.

The server 300 performs a verification process on the user identification code (S606).

The server 300 transmits the verification result to the display device 100 (S607).

Unlocking process (steps S608, S609, S610, S611): If the user identification code is verified as correct by the server 300, that is, the verification result is correct, the display device 100 generates a user data request signal (S608); the display device 100 sends the user data request signal to the server 300 to request the server 300 to provide user data (S609); the server 300 sends user data corresponding to the user identification code to the display device 100 based on the user data request signal (S610); the display device 100 receives the user data, and performs a personalized setting of the display device 100 according to the received user data, and unlocks the screen 150, allowing the screen 150 to display images (S611), so that the user can operate the display device 100.

In one embodiment, the unlocking method of the display device of the disclosure further considers multi-user scenarios. When multiple users holding multiple user terminal devices approach the display device 100, the unlocking method of the display device adopts the following steps to handle potential conflict situations: UWB signal priority ordering: When the UWB communication unit 130 of the display device 100 respectively receives UWB signals sent by multiple user terminal devices 200, multiple user terminal devices 200 establish UWB communication connections with the display device 100, the display device 100 determines that multiple location information between multiple user terminal devices 200 and the display device 100 all match the preset condition, the processor 110 of the display device 100 will perform priority ordering on these UWB signals. The basis for ordering includes: (a) distance condition: one of multiple user terminal devices that has the shortest distance between the user terminal device and the display device. The display device receives the user identification code of the user terminal device, wherein the user terminal device has the shortest distance to the display device. (b) angle condition: one of multiple user terminal devices is located at a position closest to 90 degrees in front of the screen of the display device. In one embodiment, (a) distance condition takes precedence over (b) angle condition.

In one embodiment, the server 300 implements a permission control procedure. For example, via the server 300, setting up a user mapping table to manage users who can use the display device. This user mapping table contains: device identification codes of multiple display devices and information of multiple users. A user can have permission to use multiple display devices. The server 300, in response to receiving the verification request signal, identifies the user identification code in the verification request signal; and via the server, searches the user mapping table to determine whether the user identification code exists, and confirms the display device that the user identification code corresponds to and can use.

This implementation brings the following advantages: In multi-person scenarios such as classrooms or meeting rooms, the display system can intelligently select the most suitable user to unlock the display device; flexible permission management: can easily set different user access permissions for different display devices, enhancing the security and manageability of the display system.

In summary, the display system, display device, and its unlocking method of the embodiments of the disclosure have at least one of the following advantages:
(1) By continuously receiving UWB signals via the display device, and obtaining location information between the display device and the user terminal device and the user identification code of the user terminal device based on UWB signals sent by the user terminal device, accurate user identification is achieved. This solves the problem of traditional display devices being unable to distinguish current users, significantly improving the security of the display system.
(2) The display device, through preset condition judgment and the server's verification process, ensures that only users with permission within the preset distance and angle range can trigger the unlocking of the display device. This not only avoids the possibility of users in other rooms mistakenly unlocking the display device but also avoids the leakage of account and password caused by users manually entering account and password in public places, improving the security of the display system. When the display device determines that the user identification code is correct, the display device automatically unlocks the screen, without requiring the user to manually operate the user terminal device and the display device, enhancing the convenience of using the display device.

In conclusion, the unlocking method of the display device of the disclosure not only improves the user's personalized experience but also effectively solves the problems of display systems in terms of convenience of use, security, and personalized experience in existing technology, providing a more efficient, secure, and friendly solution for smart education and office environments.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. An unlocking method, adapted for a display system, the display system comprising a display device, a server and a user terminal device, wherein the display device is communicatively connected to the server, the method comprising:
via the user terminal device, continuously transmitting an ultra wideband signal;
via the display device, in response to receiving the ultra wideband signal, and obtaining location information of the user terminal device and the display device and a user identification code based on the ultra wideband signal;
via the display device, in response to the location information matching a preset condition, sending a verification request signal containing the user identification code to the server;
via the server, in response to receiving the verification request signal, performing a verification process on the user identification code and generating a verification result;
via the server, transmitting the verification result to the display device, wherein the verification result is configured to indicate whether the user identification code is correct; and
via the display device, in response to receiving the verification result, unlocking a screen of the display device.

2. The unlocking method of claim 1, further comprising:
via the display device, in response to the verification result, sending a user data request signal to the server, wherein the verification result represents that the user identification code is correct;
via the server, in response to receiving the user data request signal, sending user data corresponding to the user identification code to the display device;
via the display device, in response to receiving the user data, and performing a personalized setting according to the user data; and
via the display device, after the personalized setting is completed, unlocking the screen of the display device.

3. The unlocking method of claim 1, wherein the preset condition comprises:
a distance between the user terminal device and the display device is less than 50 centimeters; and
the user terminal device is located within a range of 0-180 degrees in front of the display device.

4. The unlocking method of claim 1, wherein the location information comprises:
a distance between the user terminal device and the display device; and
an angle of the user terminal device relative to the display device.

5. The unlocking method of claim 1, the method further comprising:
via the user terminal device, executing an interactive application;
via the interactive application, periodically transmitting the ultra wideband signal containing the user identification code.

6. The unlocking method of claim 2, wherein the user data comprises:
a user personal data, including a user name and a user photo;
third-party account information, configured to access files from a third-party account; and
setting parameters of the display device.

7. The unlocking method of claim 1, wherein when a plurality of user terminal devices are near the display device and match the preset condition, the method further comprises:
via the display device, sorting a processing order of a plurality of ultra wideband signals sent by the plurality of user terminal devices, wherein the order is based on a distance condition and an angle condition, the distance condition having higher priority than the angle condition.

8. The unlocking method of claim 1, wherein the user terminal device is a smartphone having an ultra-wideband communication unit.

9. A display system, comprising:
a user terminal device, is configured to transmit an ultra wideband signal;
a display device, is configured to receive the ultra wideband signal; and
a server, communicatively connected to the display device, wherein
the display device is configured to obtain location information of the user terminal device relative to the display device and a user identification code based on the ultra wideband signal;
the display device is configured to determine whether the location information matches a preset condition, and send a verification request signal containing the user identification code to the server;
the server is configured to receive the verification request signal, perform a verification process on the user identification code to generate a verification result, and transmit the verification result to the display device, wherein the verification result is configured to indicate whether the user identification code is correct; and
the display device is configured to receive the verification result, and unlock a screen of the display device.

10. The display system of claim 9, wherein:
the display device is configured to send a user data request signal to the server;
the server is configured to receive the user data request signal, send a user data corresponding to the user identification code to the display device;
the display device is configured to receive the user data, and perform a personalized setting according to the user data; and
the display device is configured to unlock the screen of the display device after the personalized setting is completed.

11. The display system of claim 9, wherein the preset condition comprises:
a distance between the user terminal device and the display device is less than 50 centimeters; and
the user terminal device is located within a range of 0-180 degrees in front of the display device.

12. The display system of claim 9, wherein the location information comprises:
a distance between the user terminal device and the display device; and
an angle of the user terminal device relative to the display device.

13. The display system of claim 9, wherein
the user terminal device is configured to execute an interactive application;
the user terminal device is configured to execute the interactive application to periodically transmit the ultra wideband signal containing the user identification code.

14. The display system of claim 10, wherein the user data comprises:
a user personal data, including a user name and a user photo;
third-party account information, is configured to access files from a third-party account; and
setting parameters of a display device.

15. The display system of claim 9, wherein when a plurality of user terminal devices are near the display device and match the preset condition:
the display device is configured to sort processing order of a plurality of ultra wideband signals sent by the plurality of user terminal devices, wherein the order is based on a distance condition and an angle condition, the distance condition having higher priority than the angle condition.

16. A display device, comprising:
an ultra-wideband communication unit, configured to receive an ultra wideband signal;
a storage device, configured to store a preset condition;
a processor, electrically coupled to the ultra-wideband communication unit and the storage device, wherein the processor is configured to:
obtain location information and a user identification code based on the ultra wideband signal, determine the location information matches the preset condition;
a communication unit, electrically coupled to the processor, configured to send a verification request signal containing the user identification code, and to receive a verification result, wherein the verification result is configured to indicate whether the user identification code is correct; and
a screen, electrically coupled to the processor, configured to unlock the screen according to the verification result.
